(19) United States
(12) Patent Application Publication
(10) Pub. No.: US 2026/0177350 A1
(43) Pub. Date: Jun. 25, 2026

(54) BUTT WITH RECOIL ABSORTION FOR ARM OR TOOL

(71) Applicants: Antonio Andrés Arrom Martorell, Alcudia (ES); Juan Mariano Bendito Vallori, Inca (ES)

(72) Inventors: Antonio Andrés Arrom Martorell, Alcudia (ES); Juan Mariano Bendito Vallori, Inca (ES)

(21) Appl. No.: 19/431,346

(22) Filed: Dec. 23, 2025

(30) Foreign Application Priority Data
Dec. 23, 2024 (EP) 24383453.8

(51) Int. Cl. F41C 23/06; B25D 17/24

(52) U.S. Cl. CPC F41C 23/06; B25D 17/24

(57) ABSTRACT

The present invention relates to a butt with recoil absorption for firearm or tool which improves recoil absorption when firing said firearm or using said tool as it features an additional buffering system to support that which is performed by the braking spring.

### CROSS-REFERENCE TO RELATED APPLICATION

This U.S. Utility application claims the benefit of European Application No. 24383453.8, filed Dec. 23, 2024, which is incorporated herein by reference in its entirety.

### OBJECT OF THE INVENTION

The present invention relates to a butt with recoil absorption for firearm or tool that improves recoil absorption when firing said firearm or using said tool.

The subject of the invention is a butt with recoil absorption for firearm or tool featuring an additional buffering system to support the buffer system provided by the braking spring and leaf spring of the butt.

### BACKGROUND OF THE INVENTION

Buffering systems designed to minimise or soften the recoil produced in firearms, specifically in long firearms that rest on the user's shoulder at the moment of firing, are known in the state of the art.

Among the foregoing KR101997741B1 is known, which relates to an improved buffer system for a firearm to reduce the recoil experienced when shooting, which comprises a breechblock housing assemble received in an upper firearm body; a lower firearm body coupled to the upper firearm body; a butt plate support bar having a cylindrical shape and coupled to the rear side of the lower firearm body; a recoil spring inserted into the butt plate support bar; a buffer assembly inserted into the butt plate support bar and pressing the recoil spring to a rear side; and a butt plate having a reception space storing the butt plate support bar, wherein in firing, the breechblock housing assembly presses the buffer assembly while being retreated and the buffer assembly presses the recoil spring to absorb a shock applied to the butt plate by the recoil spring, such that the shock force of the breechblock housing assembly hitting a butt plate side is reduced and is quickly returned to an initial position, and thus a series of shots can be performed.

Document CN111578778 is also known, which relates to a device for reducing recoil force of an automatic shotgun, which comprises a recoil spring cylinder, a buffer spring seat, a buffer tube, a buffer plug, a recoil spring, a buffer spring guide column, a buffer spring, a butt spacing nut, a butt and a butt bottom, wherein the buffer spring seat sleeves the recoil spring cylinder, and is fixedly connected with the recoil spring cylinder through a pin; the buffer tube and the buffer plug are coaxially and fixedly connected together through a pin; the recoil spring is in a cavity of the recoil spring cylinder; the buffer tube and the buffer plug penetrate through the recoil spring; the butt spacing nut is located at the sealed end of the recoil spring cylinder, and is fixedly connected with the recoil spring cylinder through a pin, and is integrally placed in the main cavity of the butt; the buffer spring guide column is fixedly connected with the buffer spring seat through a pin, and penetrates through the buffer spring; the buffer spring is arranged in an auxiliary cavity of the butt; and finally, the butt is fixedly connected with the butt bottom through screws and bottom supporting nuts. The device for reducing the recoil force of an automatic shot firearm disclosed by the invention can reduce the recoil force produced when firing a shotgun, and has a simple structure, and the influence on the shooting accuracy is reduced.

However, said systems fail to fully buffer the recoil produced by the firearm.

Percussion or impact tools, such as pneumatic hammers, are also known, which are used in a vertical position on the ground and which produce a recoil on the user.

The butt with recoil absorption for firearm or tool of the present invention solves all of the above drawbacks.

### DESCRIPTION OF THE INVENTION

The present invention relates to a butt with recoil absorption for firearm or tool comprising:
a portion solidly connected to a firearm body comprising:
   an intake tube configured to be coupled to a firearm;
   an arm of the intake tube configured to serve as a housing for the intake tube;
   a buffering cylinder attached to the arm of the intake tube;
a rod arranged inside the buffering cylinder comprising a first end protruding from one end of said buffering cylinder and a second end comprising a buffering piston configured to slide inside the buffering cylinder;
a first braking spring solidly connected to the arm of the intake tube and configured to be in contact with both the arm of the intake tube and:
a first portion movable relative to the firearm body, comprising:
   an enveloping sleeve which surrounds the arm of the intake tube and allows said arm of the intake tube to move inside the enveloping sleeve;
   a butt body attached to the enveloping sleeve;
   a leaf spring comprising a first arm arranged in contact with the first braking spring and joined to the first end of the rod, and a second arm, wherein the leaf spring is configured to at least partially absorb the recoil movement of the firearm through the first braking spring and the rod comprising at its second end the buffering piston;
a second portion movable relative to the firearm body and relative to the first movable portion comprising:
   a butt plate attached to the second arm of the leaf spring and configured to allow the butt body to slide relative to said butt plate.

Thus configured, the butt with recoil absorption for firearm of the present invention improves recoil absorption when firing said firearm or using said tool, as it features an additional buffering system to support that which is performed by the first braking spring.

Thus, it can be used in guns, firearms of any rate and calibre such as propelled rocket launchers, portable recoilless firearms, portable missile launchers, portable revolver or single shot grenade launchers, firearms and heavy machine firearms with shafts and shoulder rests, airsoft guns, crossbows and any type of electric, pneumatic or hydraulic impact or percussion tools.

Optionally, the second movable portion further comprises a second braking spring solidly connected to the second arm of the leaf spring and the butt plate configured to be in contact with both the second arm of the leaf spring and the butt plate, wherein the second braking spring is configured to at least partially absorb the recoil movement of the firearm.

In this way, the butt with recoil absorption for firearm of the present invention improves recoil absorption when firing a shot with said firearm, as it features an additional buffering system to support that which is performed by the first braking spring and the butt leaf spring.

Optionally, the leaf spring comprises a notch provided between the first arm and the second arm, which increases the flexibility of the leaf spring. Preferably, the notch is in the form of a circular sector.

Furthermore, the displacement of the enveloping sleeve which surrounds the arm of the intake tube is limited by the compression force exerted by the first braking spring and by the rod comprising the piston arranged inside the buffering cylinder when in contact with or joined to the first arm of the leaf spring.

Moreover, the leaf spring also absorbs the force exerted by the user on the butt plate when the firearm is resting, preferably on a user's shoulder.

The butt plate, preferably watertight, being part of the second movable portion, can be moved relative to the part solidly connected to the firearm body and the first movable portion, so that, in the event of any recoil movement of the firearm, the butt plate moves towards the butt body or, in other words, the butt body moves towards the butt plate, depending on which part is taken as a reference, where the butt plate also absorbs any impulse or recoil derived from the user.

Optionally, the arm of the intake tube can be moved relative to the intake tube. Preferably, the arm of the intake tube comprises a push-button selectively couplable to one hole of a set of intake tube holes, so that the extension of the firearm can be shortened or lengthened by varying the anchorage of the push-button to one or the other hole of the set of intake tube holes. Preferably, the intake tube hole set is arranged on a side wall of the intake tube, making it easier for the user to see when adjusting the extension of the firearm.

Optionally, the arm of the intake tube comprises a first housing configured to house the buffering cylinder inside of which the rod is arranged.

Optionally, the first braking spring comprises a first end configured to be in contact with the arm of the intake tube and a second end configured to be in contact with the leaf spring.

Optionally, the portion that is solidly connected to the firearm body further comprises a cap with a hole couplable to a second housing of the arm of the intake tube, configured to allow passage of the first end of the rod and to keep a lubricating fluid sealed, suitable for ambient temperature, between the buffering piston and the buffering cylinder.

The buffering cylinder is fixed to the arm of the intake tube, and is therefore solidly connected to the firearm, while the piston is movable and is therefore part of the first movable portion. Optionally, the buffering cylinder comprises a gas therein which acts as an interface between the portion that is solidly connected to the firearm body and the first movable portion, at least partially buffering the recoil of the firearm.

Preferably, the buffering piston comprises a filling valve in the arm of the intake tube, wherein the filling valve is configured to regulate the pressure and consequently the buffering of the firearm or tool.

Optionally, the arm of the intake tube comprises a third housing configured to house the first end of the first braking spring.

Optionally, the second braking spring comprises a first end configured to be in contact with the second arm of the leaf spring and a second end configured to be in contact with the butt plate.

Optionally, the second arm of the leaf spring comprises a first housing configured to house the first end of the second braking spring.

Optionally, the first arm of the leaf spring comprises a hole configured to allow passage of the first end of the rod.

Optionally, the first movable portion comprises anchoring means configured to anchor the first end of the rod to the first arm of the leaf spring once it is positioned through the hole of the first arm of the leaf spring.

Optionally, the leaf spring is V-shaped.

Optionally, the leaf spring has an inverted V shape. Preferably, the first arm of the leaf spring comprises a first leg, preferably straight, configured to be arranged in contact with the first braking spring and a second leg configured to be joined to the first end of the rod. Preferably, the first arm of the leaf spring comprises a step between the first straight leg and the second leg.

Optionally, the butt body surrounds the enveloping sleeve.

Optionally, the first braking spring is arranged in a higher position relative to the second braking spring and/or the first end of the rod. Preferably, the first end of the rod is arranged in a higher position relative to the second braking spring.

Optionally, the enveloping sleeve comprises an inner bore and a lubrication hole connected to said inner bore, configured to allow the passage of a lubricant between the enveloping sleeve and the arm of the intake tube.

Optionally, the butt plate is configured to allow said butt body to slide on the outside of said butt plate.

Optionally, the butt further comprises a butt locking mechanism configured to block recoil absorption. Preferably, the butt locking mechanism is manually operated.

The invention also relates to a firearm comprising the butt with recoil absorption for firearm described above.

### DESCRIPTION OF THE DRAWINGS

As a complement to the description provided herein, and for the purpose of helping to make the features of the invention more readily understandable, in accordance with a preferred practical exemplary embodiment thereof, said description is accompanied by a set of drawings constituting an integral part of the same, wherein by way of illustration and not limitation, the following has been represented:

FIG. 1 shows a perspective view of the butt with recoil absorption for firearm or tool of the present invention.

FIG. 2 shows a cross-sectional perspective view of the butt with recoil absorption for firearm of the present invention according to a first exemplary embodiment.

FIG. 3 shows a cross-sectional perspective view of the butt with recoil absorption for firearm of the present invention according to a second exemplary embodiment.

FIG. 4 shows a perspective view of the intake tube of the invention.

FIG. 5 shows a perspective view of the arm of the intake tube.

FIG. 6 shows a lower view of the intake tube-arm of the intake tube assembly.

FIG. 7 shows a perspective view of the enveloping sleeve that surrounds the arm of the intake tube.

FIG. 8 shows a perspective view of the butt body-enveloping sleeve-leaf spring assembly according to a second exemplary embodiment.

FIG. 9 shows a perspective view of a locking mechanism of the butt with recoil absorption for firearm of the present invention in the locked position of said recoil absorption.

FIG. 10 shows a rear side view of the butt with recoil absorption for firearm of the present invention including the locking mechanism in the non-locking position of the recoil absorption.

FIG. 11 shows a cross-sectional view AA of FIG. 10.

FIG. 12 shows a detail of the locking mechanism in the non-locked position of the recoil absorption.

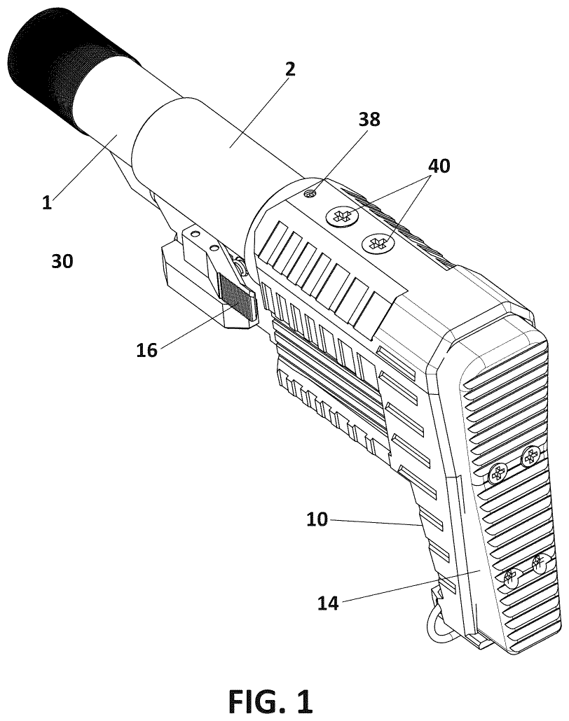

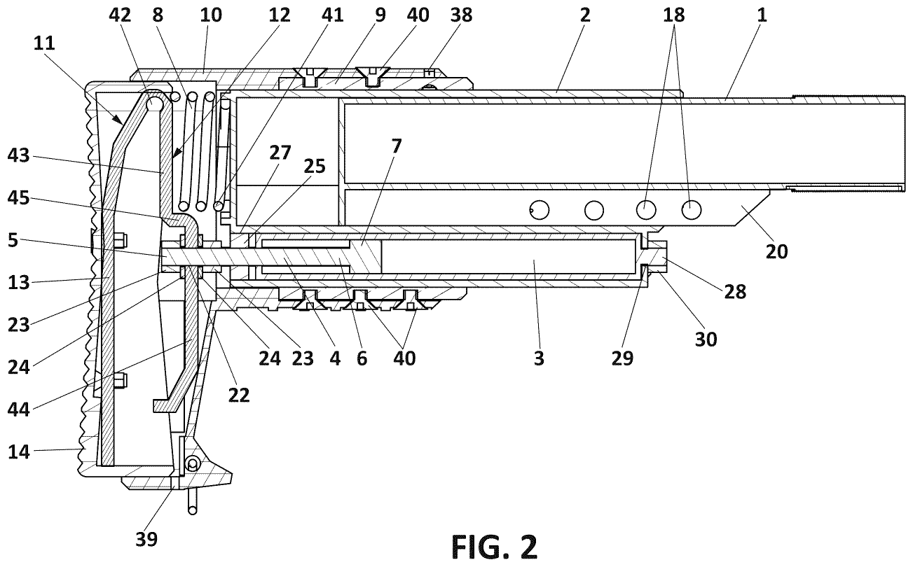

### PREFERRED EMBODIMENT OF THE INVENTION

With the aid of the figures, a first exemplary preferred embodiment of a butt with recoil absorption for a high shooting rate firearm, long firearm, precision firearm, sporting shotgun or similar, is described below, the butt comprising:
a portion solidly connected to the firearm body and comprising:
   an intake tube (1) configured to be coupled to a firearm;
   an arm (2) of the intake tube (1) configured to serve as a housing for the intake tube (1);
   a buffering cylinder (3) attached to the arm (2) of the intake tube (1);
a rod (4) arranged inside the buffering cylinder (3) comprising a first end (5) protruding from one end of said buffering cylinder and a second end (6) comprising a buffering piston (7) configured to slide inside the buffering cylinder (3);
a first braking spring (8) solidly connected to the arm (2) of the intake tube (1) and configured to be in contact with both the intake tube (1) arm (2) and:
a first portion movable relative to the firearm body, comprising:
   an enveloping sleeve (9) which surrounds the arm (2) of the intake tube (1) and allows said arm (2) of the intake tube (1) to move inside the enveloping sleeve (9);
   a butt body (10) attached to the enveloping sleeve (9);
   a leaf spring (11) comprising a first arm (12) arranged in contact with the first braking spring (8) and joined to the first end (5) of the rod (4), and a second arm (13), wherein the leaf spring (11) is configured to at least partially absorb the recoil movement of the firearm through the first braking spring (8) and the rod (4) comprising at its second end (6) the buffering piston (7);
a second portion movable relative to the firearm body and relative to the first movable portion comprising:
   a butt plate (14) attached to the second arm (13) of the leaf spring (11) and configured to allow the butt body (10) to slide relative to said butt plate (14).

In this first exemplary embodiment, the arm (2) of the intake tube (1) can be moved relative to the intake tube (1), wherein the arm (2) of the intake tube (1) comprises a push button (16) with

a pin (17) selectively couplable to one hole of a set of intake tube (1) holes (18), wherein the push button (16) is coupled to the arm (2) of the intake tube (1) in a hinged manner and/or via a recovery spring (19), so that the extension of the firearm can be shortened or lengthened by varying the anchorage of the pin (17) in one or the other hole of the set of holes (18) of the intake tube (1). The set of holes (18) of the intake tube (1) is arranged in a side wall (20) of the intake tube (1).

The arm (2) of the intake tube (1) comprises a first, preferably lower, housing (21), configured to house the buffering cylinder (3) inside of which the rod (4) is arranged, wherein the first arm (12) of the leaf spring (11) comprises a hole (22) configured to allow the passage of the first end (5) of the rod (4), wherein the first movable portion comprises anchoring means (23, 24), preferably nuts (23) and washers (24), configured to anchor the first end (5) of the rod (4) to the first arm (12) of the leaf spring (11) once it is arranged through the hole (22) of the first arm (12) of the leaf spring (11).

The portion that is solidly connected to the firearm body further comprises a screwed cap (25) with a hole (26) couplable to a second, preferably cylindrical, housing (27) of the arm (2) of the intake tube (1) that allows the passage of the first end (5) of the rod (4) and keeps a lubricating fluid (not shown) sealed between the buffering piston (7) and the buffering cylinder (3). The screwed cap (25) further prevents the rod (4) from carrying out vertical oscillating movements or non-allowed deflections due to its own geometry.

The buffering cylinder (3) comprises a nipple (28) couplable into the hole (29) of the first housing (21) of the arm (2) of the intake tube (1) for attaching the buffering cylinder (3) in the first housing (21) by means of a nut (30).

The first braking spring (8) comprises a first end (31) configured to be in contact with the arm of the intake tube due to the presence of a third, preferably cylindrical, housing (32) of the arm (2) of the intake tube (1) configured to house said first end (22), and a second end (41) configured to be in contact with the leaf spring (11). Preferably, the third housing (32) is defined by a set of ledges, although it could also be formed by a continuous ledge, preferably circumferential.

As shown in FIG. 8, the butt body (10) outwardly surrounds the enveloping sleeve (9). The enveloping sleeve (9) comprises an inner bore (37) and a lubrication hole (38) connected to said inner bore (37), configured to allow the passage of a lubricant between the enveloping sleeve (9) and the arm (2) of the intake tube (1).

The butt body (10) comprises a drain hole (39) arranged in the lower portion thereof.

The butt body (10) is attached to the enveloping sleeve by means of screws (40).

The butt plate (14) is configured to allow said butt body (10) to slide on the outside of said butt plate (14), or, in other words, the butt plate (14) slides on the inside of the butt body (10), depending on the reference taken. In another exemplary embodiment, not shown, the butt plate (14) is configured to allow said butt body (10) to slide on the inside of said butt plate (14).

The leaf spring (11) comprises a notch (42) provided between the first arm (12) and the second arm (13), which increases the elasticity of the leaf spring (11).

In this first exemplary preferred embodiment, the leaf spring (11) has an inverted V shape, wherein the first arm (12) of the leaf spring (11) comprises a first straight leg (43) configured to be in contact with the first braking spring (8), a second leg (44) configured to be joined to the first end (5) of the rod (4) and a step (45) between the first straight leg (43) and the second leg (44).

In this first preferred exemplary embodiment, the first braking spring (8) is located at a higher position relative to the first end (5) of the rod (4). Preferably, the first braking spring (8) is a coil spring.

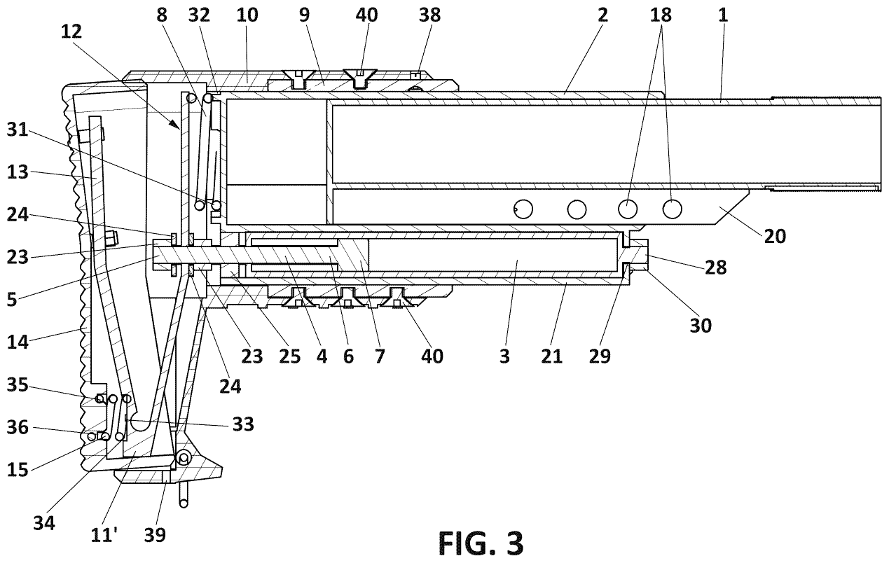

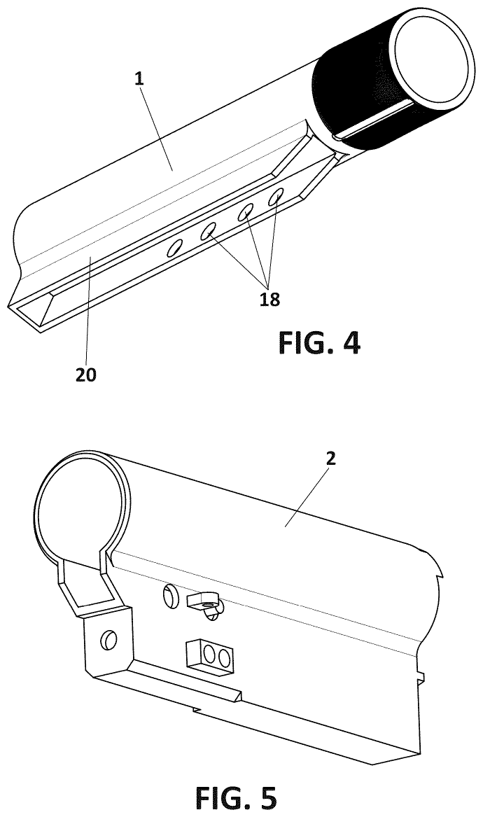

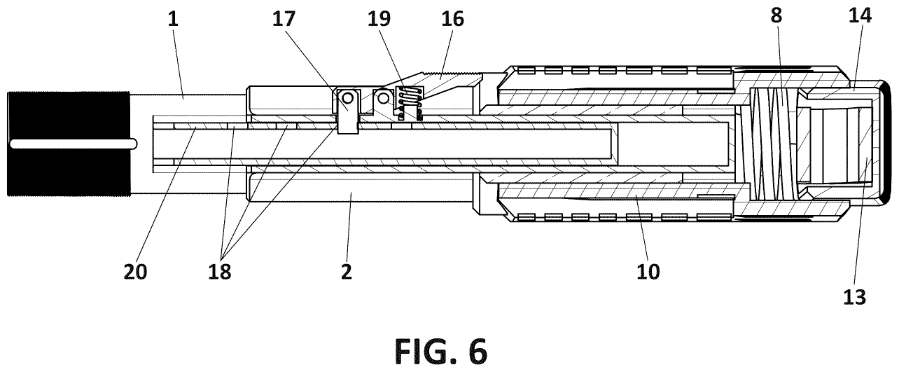

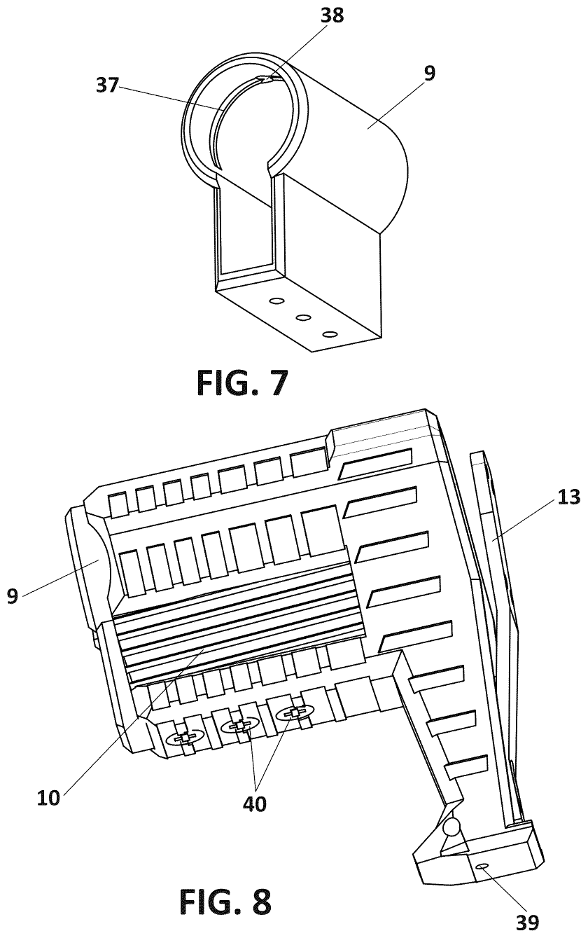

In a second preferred exemplary embodiment of the butt with recoil absorption for a high shooting rate firearm, long firearm, precision firearm, sporting shotgun or similar, shown in FIG. 3, the butt has the features described above for the first exemplary embodiment, and in addition, the second movable portion of the butt comprises a second braking spring (15) attached to the second arm (13) of the leaf spring (11′) and to the butt plate (14) configured to be in contact with both the second arm (13) of the leaf spring (11′) and the butt plate (14), wherein the second braking spring (15) is configured to at least partially absorb the recoil movement of the firearm.

The second arm (13) of the leaf spring (11′) comprises a first housing (33) preferably cylindrical, configured to house a first end (34) of the second braking spring (15) which further comprises a second end (35) configured to be in contact with the butt plate (14), preferably housed in a circular bore (36) of the butt plate.

In the second preferred exemplary embodiment, the first braking spring (8) is arranged in an upper position relative to the first end (5) of the rod (4) and said first end (5) of the rod (4) is arranged in an upper position relative to the second braking spring (15). Preferably, both the first braking spring (8) and the second braking spring (15) are coil springs. Also preferably, the first braking spring (8) has a diameter and the second braking spring (15) has a diameter, wherein the diameter of the first braking spring (8) is greater than the diameter of the second braking spring (15). Preferably, the diameter of the first braking spring (8) is between twice and four times the diameter of the second braking spring (15).

In this second preferred exemplary embodiment, the leaf spring (11) is V shaped.

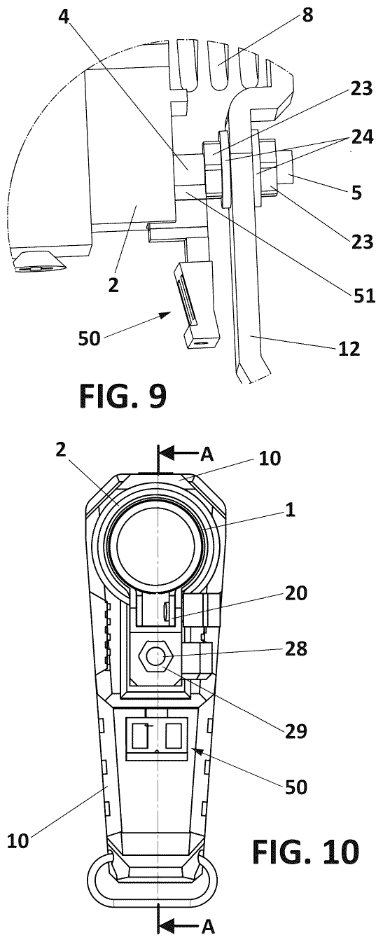

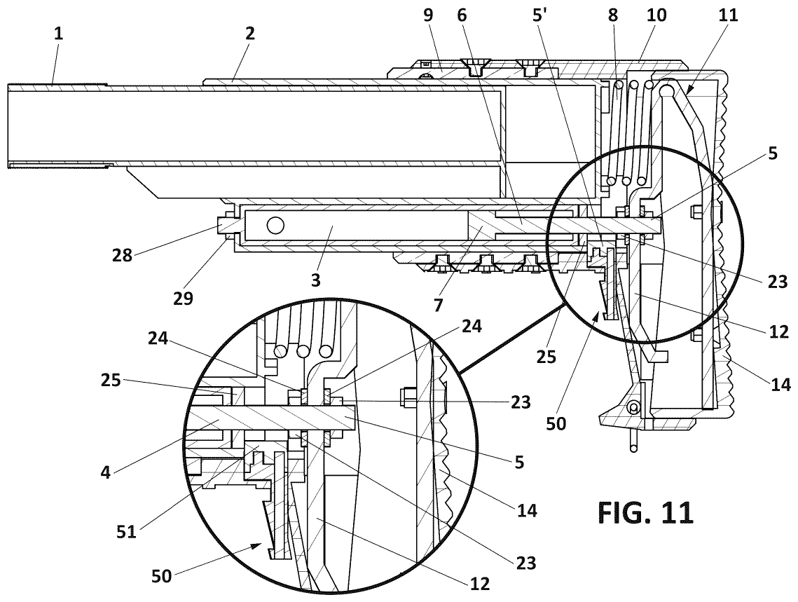

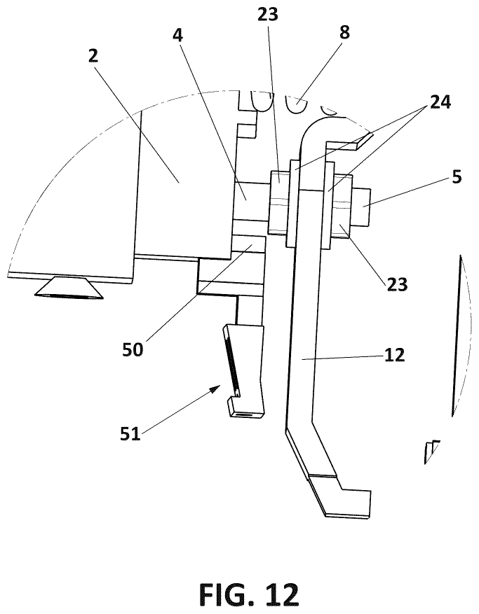

The butt may comprise, for each of the exemplary embodiments described above, and as shown in FIGS. 9 to 12, a butt locking mechanism (50) configured to block recoil absorption. Preferably, the locking mechanism (50) comprises a stop (51) that can be housed in the space between the anchoring means (23) of the first movable portion and the screwed cover (25) of the portion that is solidly connected to the firearm body.

What is claimed is:

1. A butt with recoil absorption for arm or tool, comprising:
a portion solidly connected to a firearm body and comprising:
an intake tube configured to be coupled to a firearm,
an arm of the intake tube configured to serve as a housing for the intake tube, and
a buffering cylinder attached to the arm of the intake tube;
a rod arranged inside the buffering cylinder comprising a first end protruding from one end of said buffering cylinder and a second end comprising a buffering piston configured to slide inside the buffering cylinder;
a first braking spring solidly connected to the arm of the intake tube and configured to be in contact with both the intake tube arm;
a first portion movable relative to the firearm body, comprising:
an enveloping sleeve which surrounds the arm of the intake tube and allows said arm of the intake tube to move inside the enveloping sleeve,
a butt body attached to the enveloping sleeve, and
a leaf spring comprising a first arm arranged in contact with the first braking spring and joined to the first end of the rod, and a second arm, wherein the leaf spring is configured at least partially absorb the recoil movement of the firearm through the first braking spring and the rod comprising at its second end the buffering piston; and
a second portion movable relative to the firearm body and relative to the first movable portion, comprising:
a butt plate attached to the second arm of the leaf spring and configured to allow the butt body to slide relative to said butt plate.

2. The butt according to claim 1, wherein the arm of the intake tube comprises a first housing configured to house the buffering cylinder inside of which the rod is arranged.

3. The butt according to claim 1, wherein the first braking spring comprises a first end configured to be in contact with the arm of the intake tube and a second end configured to be in contact with the leaf spring.

4. The butt according to claim 3, wherein the arm of the intake tube comprises a third housing configured to house the first end of the first braking spring.

5. The butt according to claim 1, wherein the portion that is solidly connected to the firearm body further comprises a cap with a hole couplable to a second housing of the arm of the intake tube configured to allow passage of the first end of the rod and to keep a lubricating fluid sealed between the buffering piston and the buffering cylinder.

6. The butt according to claim 1, wherein the first arm of the leaf spring comprises a hole configured to allow passage of the first end of the rod.

7. The butt according to claim 6, wherein the first movable portion comprises an anchoring means configured to anchor the first end of the rod to the first arm of the leaf spring once the first end of the rod is arranged through the hole of the first arm of the leaf spring.

8. The butt according to claim 1, wherein the second movable portion further comprises a second braking spring solidly connected to the second spring arm of the leaf spring and to the butt plate configured to be in contact with both the second arm of the leaf spring and the butt plate, wherein the second braking spring is configured to at least partially absorb the recoil movement of the firearm.

9. The butt according to claim 8, wherein the second braking spring comprises a first end configured to be in contact with the second arm of the leaf spring and a second end configured to be in contact with the butt plate.

10. The butt according to claim 9, wherein the second arm of the leaf spring comprises a first housing configured to house the first end of the second braking spring.

11. The butt according to claim 8, wherein the first braking spring is arranged in a higher position relative to the second braking spring and/or the first end of the rod, which in turn is arranged in a higher position relative to the second braking spring.

12. The butt according to claim 1, wherein the enveloping sleeve comprises an inner bore and a lubrication hole connected to said inner bore, configured to allow passage of a lubricant between the enveloping sleeve and the arm of the intake tube.

13. The butt according to claim 1, wherein the butt plate is configured to allow said butt body to slide on an outside or on an inside of said butt plate.

14. The butt according to claim 1, wherein the arm of the intake tube can be moved relative to the intake tube.

15. The butt according to claim 13, wherein the arm of the intake tube comprises a push button selectively couplable to a hole of a set of holes of the intake tube, wherein the set of holes of the intake tube is arranged on a side wall of the intake tube.

16. The butt according to claim 1, wherein the leaf spring comprises a notch arranged between the first arm and the second arm.

17. The butt according to claim 1, further comprising a butt locking mechanism configured to block recoil absorption.

18. A firearm or tool comprising the butt of claim 1.
